(19) United States
(12) Patent Application Publication
(10) Pub. No.: US 2020/0273065 A1
(43) Pub. Date: Aug. 27, 2020

(54) METHOD AND APPARATUS FOR MOBILE USER BEHAVIOR MONITORING

(71) Applicant: Ford Global Technologies, LLC, Dearborn, MI (US)

(72) Inventors: Jae Hyung Lim, Canton, MI (US); John William Schmotzer, Canton, MI (US); Daryl Martin, Kitchener (CA)

(21) Appl. No.: 16/283,247

(22) Filed: Feb. 22, 2019

(51) Int. Cl. G06Q 30/02; H04W 4/44

(52) U.S. Cl. CPC G06Q 30/0246; G06Q 30/0261; H04W 4/44

(57) ABSTRACT

An offer is played during a content stream, the offer including a tracking characteristic. The tracking characteristic is stored in a vehicle memory. Vehicle travel data corresponding to the tracking characteristic is recorded, responsive to storing the tracking characteristic. At least one change in vehicle behavior indicated by the recorded data is identified, based on comparison to previously recorded vehicle data. The change in vehicle behavior, the recorded data, and an identification of the offer is reported responsive to identifying the change in vehicle behavior.

### TECHNICAL FIELD

The illustrative embodiments generally relate to methods and apparatuses for mobile user behavior monitoring.

### BACKGROUND

Vehicular infotainment systems are capable of providing a wide variety of content. From video to radio to streaming audio, these systems can access applications residing both on the vehicle and on a user's mobile device.

Because of the safety concerns related to driving, it is not uncommon for an automobile manufacturer to retain some control over what content can be played when. The manufacturer can also use the vehicle computer to push notifications and other information to a center display.

At the same time, people providing offers to vehicle occupants may have an interest in determining whether those occupants respond to an offer. Typically, however, the offer provider has significantly less access to a vehicle computer for information gathering purposes, than a manufacturer does.

### SUMMARY

In a first illustrative embodiment a system includes a processor configured to insert, during playback of a media content stream, an offer including a tracking characteristic. The processor is also configured to record vehicle travel data corresponding to the tracking characteristic and associated with a stored tracking characteristic, stored in the vehicle memory. The processor is further configured to identify at least one change in user behavior indicated by the recorded data, based on comparison of the vehicle travel data to previously-recorded vehicle data and report the change in vehicle behavior, the recorded data, and an identification of the offer, responsive to identifying the change in vehicle behavior.

In a second illustrative embodiment, a method includes identifying a business located at a vehicle stopping location indicated by a vehicle entering a park state. The method also includes determining that the business corresponds to an offer previously presented by the vehicle within a tracking time period defined by data included with the offer. The method further includes recording data, of a type specified by the data included with the offer, related to the stop and reporting the recorded data along with identification of the offer.

In a third illustrative embodiment, a non-transitory storage medium stores instructions that, when executed by a processor, cause the processor to perform the method comprising determining a user stop at a business for which an offer was previously presented in-vehicle, the stop being within a predefined time window following presentation of the offer and defined by the offer. The method also includes recording user data relating to the stop, the offer defining which data to record. The method further includes determining a change from previously-observed user behavior recorded with respect to a brand associated with the business, by comparing the recorded user data to previously observed and recorded data and reporting the deviance, including identification of the offer.

### BRIEF DESCRIPTION OF THE DRAWING

FIG. 1 shows an illustrative vehicle computing system;

FIG. 2 shows an illustrative process for behavior tracking;

FIG. 3 shows an illustrative process for offer-based tracking initialization;

FIG. 4 shows an illustrative process for comparative behavior data gathering; and

FIG. 5 shows an illustrative example of a process for behavior analysis.

### DETAILED DESCRIPTION

As required, detailed embodiments are disclosed herein; it is to be understood, however, that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

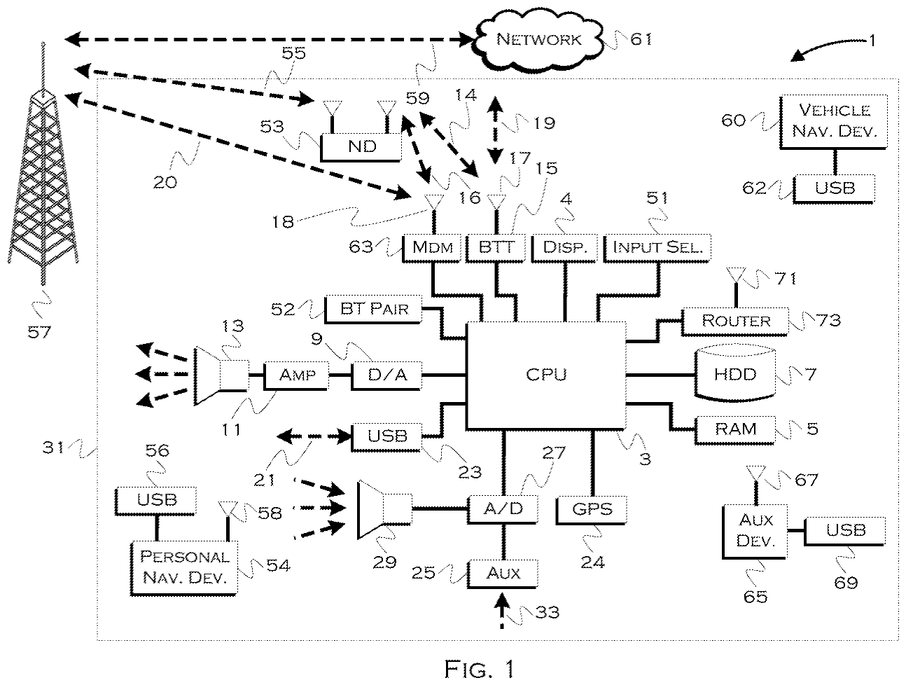

FIG. 1 illustrates an example block topology for a vehicle based computing system 1 (VCS) for a vehicle 31. A vehicle provided with a vehicle-based computing system may contain a visual front-end interface 4 located in the vehicle. The user may also be able to interact with the interface if it is provided, for example, with a touch-sensitive screen. In another illustrative embodiment, the interaction occurs through, for example, button presses, spoken dialog system with automatic speech recognition and speech synthesis.

In the illustrative embodiment 1 shown in FIG, 1, a processor 3 controls at least some portion of the operation of the vehicle-based computing system. Provided within the vehicle, the processor 3 allows for onboard processing of commands and routines. Further, the processor 3 is connected to both non-persistent 5 and persistent storage 7. In this illustrative embodiment, the non-persistent storage 7 is random access memory (RAM) and the persistent storage 5 is a hard disk drive (HDD) or flash memory. In general, persistent memory 5 can include all forms of memory that maintain data when a computer or other device is powered down. These include, but are not limited to, HDDs, compact discs (CDs), digital video discs (DVDs), magnetic tapes, solid state drives, portable universal serial bus (USB) drives and any other suitable form of persistent memory.

The processor 3 is also connected to a number of different inputs allowing the user to interface with the processor 3. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs, input to both the microphone 29 and the auxiliary connector 33 is converted from analog to digital by a converter 27 before being passed to the processor. Although not shown, numerous of the vehicle components and auxiliary components in communication with the processor 3 may use a vehicle network (such as, but not limited to, a CAN bus) to pass data to and from the processor 3 (or components connected thereto).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system uses the BLUETOOTH transceiver 15 to communicate via antenna 17 with a user's nomadic device (ND) 53 (e.g., cell phone, smart phone, PDA, or any other device having wireless remote network connectivity). The nomadic device 53 can then be used to communicate signal 59 with a network 61 outside the vehicle 31 through, for example, communication 55 with a cellular tower 57 or Wi-Fi access point.

Exemplary communication between the nomadic device 53 and the BLUETOOTH transceiver 15 is represented by signal 14.

Pairing of a nomadic device 53 with the BLUETOOTH transceiver 15 can be instructed through a button 52 or similar input. Accordingly, the processor 3 is instructed that the onboard BLUETOOTH transceiver 15 will be paired with a nomadic device.

Data may be communicated between processor 3 and network 61 utilizing, for example, a data-plan, data over voice, or DTMF tones associated with nomadic device 53. Alternatively, it may be desirable to include an onboard modem 63 having antenna 18 in order to cellularly communicate 16 data between processor 3 and network 61.

In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor 3 is provided with an operating system including an application programming interface (API) to communicate with modem application software. The modem application software may access an embedded module or firmware on the BLUETOOTH transceiver 15 to complete wireless communication 14 with a remote BLUETOOTH transceiver (such as that found in a nomadic device 53). Bluetooth is a subset of the IEEE 802 PAN (personal area network) protocols. IEEE 802 LAN (local area network) protocols include and have considerable cross-functionality with IEEE 802 PAN. Both are suitable for wireless communication within a vehicle. Another communication format that can be used in this realm is free-space optical communication non-standardized consumer IR protocols.

In another embodiment, nomadic device 53 includes a modem for voice band or broadband data communication. In a data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In still another embodiment, nomadic device 53 is replaced with a cellular communication device (not shown) that is installed in vehicle 31. In yet another embodiment, the nomadic device 53 may be a wireless local area network (LAN) device capable of communication over, for example (and without limitation) a network.

In one embodiment, incoming data can be passed through the nomadic device 53 via a data-over-voice or data-plan, through the onboard BLUETOOTH transceiver 15 and into the vehicle's internal processor 3. In the case of certain temporary data, for example, the data can be stored on the HDD 7 or other storage media until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61.

Further, the processor 3 could be in communication with a variety of other auxiliary devices 65. These devices can be connected through a wireless 67 or wired 69 connection (e.g. USB). Auxiliary devices 65 may include, but are not limited to, personal media players, wireless health devices, portable computers, and the like.

Also, or alternatively, the processor 3 could be connected to a vehicle based wireless router 73, using for example a Wi-Fi (IEEE 802.11) 71 transceiver. This could allow the processor 3 to connect to remote networks in range of the local router 73.

In addition to having exemplary processes executed by a vehicle computing system located in a vehicle 31, in certain embodiments, the exemplary processes may be executed by a computing system in communication with a vehicle computing system. Such a system may include, but is not limited to, a wireless device 53 (e.g., and without limitation, a mobile phone) or a remote computing system (e.g., and without limitation, a server on a remote network 61) connected through the wireless device 53 or a vehicle modem 63. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device 53, then it is likely that the wireless device 53 is not performing that portion of the process, since the wireless device would not send and receive information with itself. One of ordinary skill in the art will understand when it is inappropriate to apply a particular VACS to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired.

With respect to the illustrative embodiments described in the figures showing illustrative process flows, it is noted that a general-purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

A manufacturer of vehicles may author software that is installed to the vehicle. Because of this, the manufacturer can control what information is displayed by the vehicle, it is possible that a manufacturer could control what information is presented to a vehicle occupant and when.

A content stream is a sequence of media content that may be presented to the vehicle occupant. As used herein, an offer is a presentation of media content for acceptance by a recipient that promotes a product, service, or event. The recipient may, for example, be a vehicle occupant. Software installed to the vehicle may be programmed to replace or insert offers in the content stream. In some cases, the manufacturer may work with a content provider to both provide the manufacturer with information about when an offer should be inserted into the content stream, as well as to provide options with respect to what information should be inserted into the content stream.

The manufacturer is in a unique position to monitor user behavior following an offer, because in many instances, the user will require transportation (e.g., their own vehicle) to follow through on an offer. For example, if the user hears an offer about food, and then drives to a corresponding restaurant, the vehicle is a good source of information about the trip. Not only can the vehicle provide the fact that the user traveled to the restaurant, but the vehicle can track whether the user deviated from a route, how long it took to travel, how far off route the user traveled, etc. Further, the manufacturer can download advertisements from a specific carrier who provides 5G services, as another source of potential insertable advertisements.

It is very difficult for an offer provider to know whether or not the user responds to an offer, how quickly the user responds, or how user behavior may change following an offer. Moreover, information about a single user may not provide particularly useful insight, as any given behavior could be attributable to a wide variety of factors.

On the other hand, by using the illustrative embodiments and the like, improved insight into the effectiveness of offers can be obtained because a local fleet of vehicles can be tracked and insights into group behavior can be determined. Further, those vehicles could present a variety of offers for the same vendor, and it can be determined which is seemingly the most effective at changing behavior. Also, because the vehicle has additional travel information, and can also observe the user's “normal” travel behavior, it is an excellent source of advance information about user travel habits and changes in those habits. As a group, the local fleet (having no particular relationship other than locality, in this example) can represent many useful data points about how behavior adjusts to given offers.

By tracking behavior over a longer period of time (days, a trip, weeks, hours, etc.) and by providing capability to delivery varied offers, at approximately the same time within a locality, for the same vendor, the illustrative embodiments improve the ability of vendors to test offers, determine the effectiveness of offers, determine specific behavior changes caused by offers and dynamically adapt offers to those that appear to be most effective. The novel, uncommon and atypical examples and concepts described herein demonstrate potential improvements achievable through use of those examples, concepts, and the like.

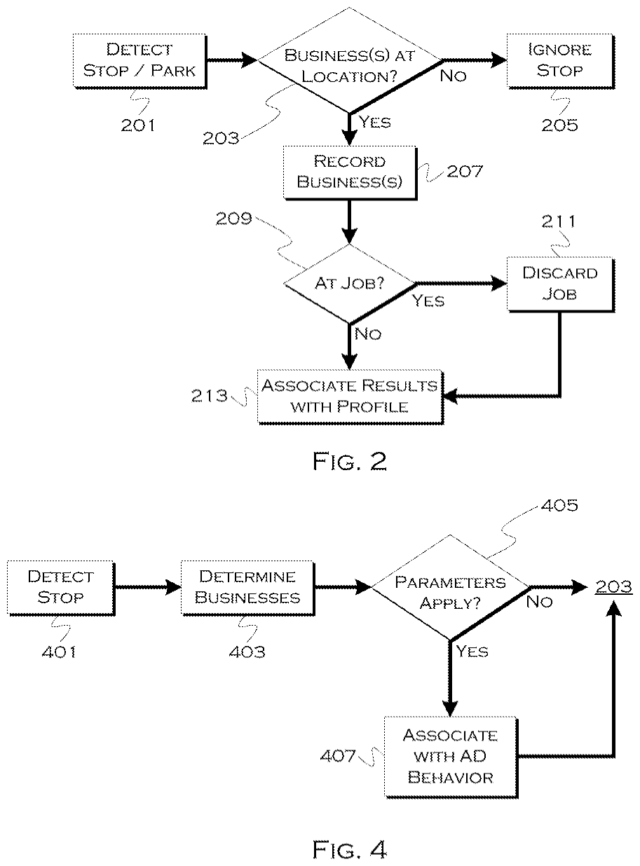

FIG. 2 shows an illustrative process for behavior tracking, performable by a vehicle processor 3. In this illustrative example, the vehicle processor 3 (and/or a phone application executing on a mobile device 59 capable of vehicle-communication) tracks user behavior to create a user baseline profile. This data can be anonymized, with respect to a user identity, and can also be securely held by a manufacturer and inaccessible by any outside party.

For example, the manufacturer can monitor user behavior before and after an offer, and merely tell an advertiser about group-based observational changes based on the monitoring (e.g., offer A caused 20% of people to add one additional visit to the vendor, offer B caused 27% of people to behave the same). This allows the manufacturer, as the controller of the vehicle data bus, to act as a “safe” intermediary for people who do not want to directly share their personal behavior data.

Behavior change, discussed in greater detail below, can be measured by observing user behavior (via vehicle behavior) and comparing behavior for a time period following an offer to behavior recorded prior to presentation of an offer. For example, if an offer included a statement that business locations of the offeror now included on-site the offeror may want to track if users remained on-site longer during visits to a business after presentation of the offer (which could be indicative of Wi-Fi usage) than the users remained during visits to the business prior to presentation of the offer. The offer itself may include data defining which types of data to track/compare and a duration (e.g. number of trips, days or other temporal parameter) for which tracking should occur for a given offer.

In the example of FIG. 2, the vehicle may detect at step 201 when the vehicle stops (off of road network) and/or parks. Stops could represent drive-through behavior, and park states could represent visits to a vendor. There are many other reasons a vehicle may stop or park as well, and it is worth noting that the vehicle can ignore stops while on a road-network. Even off of the road, however, parking lots may correlate to many things, and the process may thus determine at step 203 whether there is one or more businesses associated with a parking lot or stop location. This can be done through a variety of techniques, including, for example, looking up local business addresses, assigning an address to a vehicle based on location, and a variety of other cross-referencing techniques, If there are no vendors or businesses associated with the stopping location, the vehicle may ignore the stop at step 205.

If there are one or more businesses located within proximity to the stop, the vehicle may make a record of those businesses at step 207. If the vehicle can communicate with a mobile device, the vehicle may further use the mobile device to determine which of the businesses is/was visited by the user, since the device can track the user's progress on foot and report back to the vehicle. While not necessary, this can help reline a profile of user behavior.

Also, there may be reasons to ignore or remove data, for example, such as when a user works at the location associated with the stop. If the vehicle determines at step 209 that the user is at work, for example, the vehicle may discard at step 211 the data related to the particular business at which the user works and possibly also any other businesses associated with the stop.

User behavior and vehicle behavior can help determine where the user works, even if the user never shares this information directly. For example, if the vehicle is parked in a lot for 6-9 hours per day, five days a week, it is a reasonable assumption that the driver of the vehicle works at that location. Once any suitable adjustments to the data have been made, the vehicle may upload the data at step 217, for association with a vehicle or user profile. Again, the user profile may have associated demographic information or not and may also be anonymous or not.

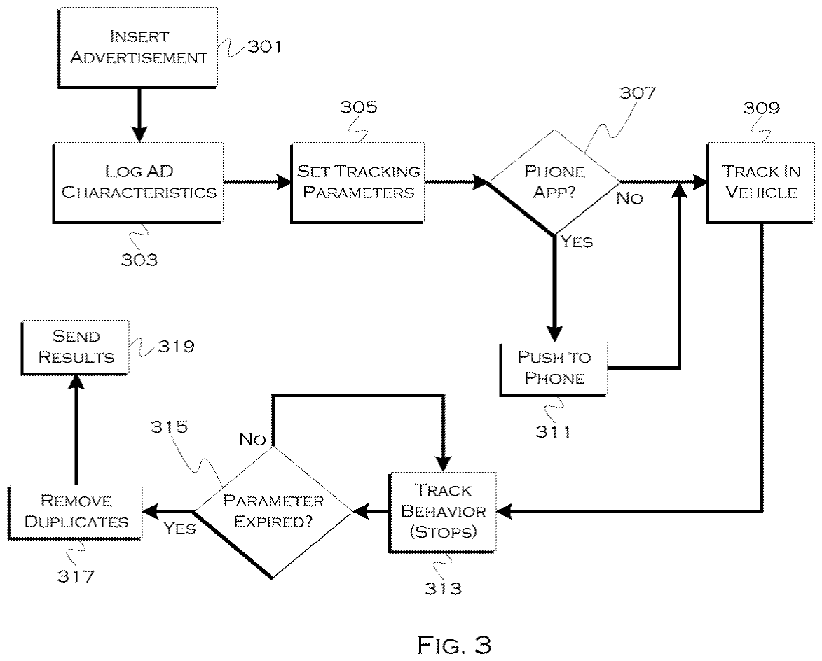

FIG. 3 shows an illustrative process for offer-based tracking initialization, which may be performed by a vehicle processor 3, for example. In this example, a vehicle manufacturer may insert an offer into a content stream, or just display the offer on a vehicle head unit (or play over vehicle audio) at step 301. This offer may have certain characteristics associated therewith, that define tracking data for the offer. Different types of offers may have different tracking parameters associated therewith, depending on the type of behavior they are designed to elicit. For example, certain offers may be designed to create immediate behavior changes (e.g., food offers), but may also request tracking for several days to see if there is a net change in behavior. On the other hand, offers for new vehicles or other expensive items may require days, weeks or even months of tracking to determine how the user responds.

In one example, the manufacturer may track a set of common behavior parameters for certain otters for predefined time periods, and in other examples the offers themselves may specify tracking parameters (e.g., time, types of behavior, stop durations, off-route travel, etc.). In examples where the offer includes tracking characteristics, the vehicle may log the characteristics for tracking user behavior at step 303. This can include locally logging the characteristics on the vehicle and pushing the characteristics at step 311 to a mobile phone 53 (if determined to be in communication at step 307) application in communication with the vehicle. The mobile phone 53 can track data while outside the vehicle, or persistently, in accordance with the tracking characteristic(s), and the vehicle can obtain this information from the mobile phone 53 at a suitable time when the vehicle and device are in communication.

The vehicle may also set tracking parameters at step 305, which can correlate to the tracking characteristics associated with the offer. Since the vehicle may play hundreds of offers per week, each offer may have individual tracking characteristics set therewith, and any behavior that corresponds to those characteristics may be tracked at step 309 by the vehicle.

For example, on a given route, a user may stop at a grocery, which may be tracked based on a grocery offer (e.g., the stop and the duration may be tracked). The vehicle may then have a planned route to a driver's work, but may deviate 10 minutes or 2 miles for food, which may be tracked based on a food offer (e.g., the stop, the deviance and the time of day may be tracked), then the user may resume travel and complete the route. The individual offers (grocery and food) may have had the respective tracked parameters associated therewith, dictating what was to be tracked. In other examples, the vehicle may track a set of fixed data, and the characteristics may simply dictate for how long the tracking should occur.

As the vehicle travels during the time periods associated with each offer (the time periods may be measured by time units or by number of trips, for example), when a vehicle stops or parks at a destination or location, the vehicle may compare that information to vendors associated with the various offers being tracked at step 313. That is, if there is no particular vendor who provided an offer that is being tracked, the stop-data may be handled as tracking normal user behavior. Normal user behavior may be tracked so that there is a basis for comparison when a given offer requests tracking changes in user behavior in response to an offer.

When a given parameter/characteristic time period expires at step 315, the vehicle may remove any duplicate data at step 317. Duplicate data includes data that corresponds to data tracked duplicatively by a mobile device and the vehicle, for example. The vehicle may then send the results at step 319, to a reporting server or to the offer-provider. The vehicle may also report at 319 periodically or any time data is gathered or represents a deviance from previously observed behavior.

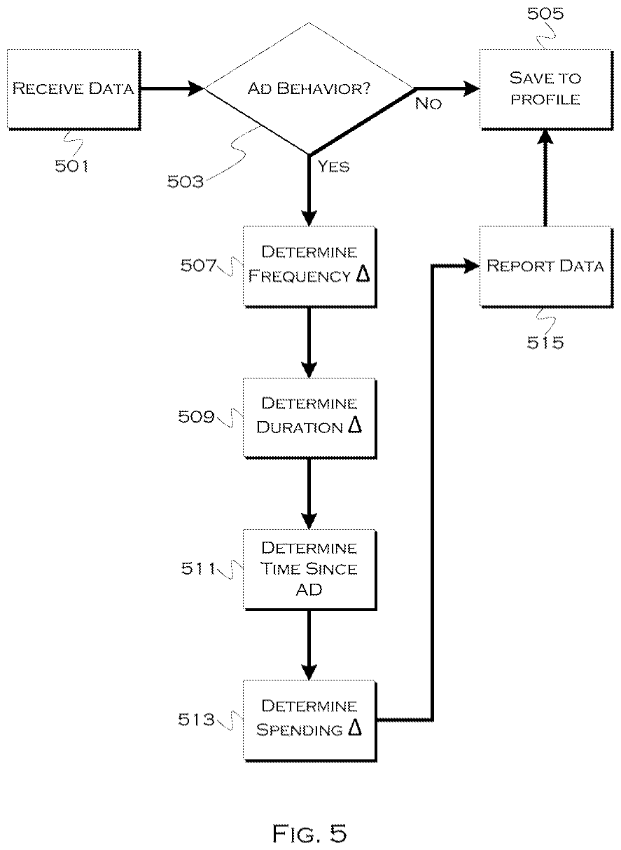

FIG. 4 shows an illustrative process for comparative behavior data gathering, which may be performed by a vehicle processor 3, for example. This illustrative process can be performed any time stop data is detected, for example. If the vehicle detects a stop or park state at step 401, the vehicle may again determine any businesses associated with the stop at step 403.

Then, in this example, the vehicle may examine stored offer data at step 405 to determine if any offers for which tracking is being performed correspond to the businesses determined to relate to a stop location. This may include, for example, communicating with a user mobile device to determine if the device recorded location or other data indicating that the user actually entered the business. This secondary information may help narrow down specific businesses that the user entered, if a number of businesses (e.g. a mall or strip mall) could be associated with a stop.

If the business corresponds to the offer for which tracking is enabled, and/or if the user entered the business (if the secondary communication with the mobile device is enabled and used), the vehicle may associate any detected behavior with the user or vehicle at step 407.

The data gathered by the vehicle can be compared to previously observed user behavior for the same business (or brand) or for a type of good. For example, the user may have traveled 10 minutes off-route to reach the business, and historically the user may travel on average only 3 minutes off route to obtain similar goods or to visit that brand. This change can be observed based on the comparison and possibly attributed to the user hearing the offer. Thus, the change or deviance, as well as the brand or offer, can be reported to a central server for processing, as it may tend to indicate an effectiveness of the offer for that particular user. In the aggregate (over a group of users), this data may indicate an observable change in behavior that is more likely attributable to the offer if observed in a certain percentage of offer-receiving people.

FIG. 5 shows an illustrative example of a process for behavior analysis. This process could be executed by a vehicle processor 3 or, for example, by a remote server (remote from the vehicle) on a remote network 61. This shows some illustrative factors that may be considered when evaluating changes in behavior resulting from offers. Since the vehicle is capable of tracking both normal behavior (behavior not associated with a post-offer tracking time period), as well as behavior occurring during, an offer-specified time period (or offer associated time period if standard tracking time periods are assigned by the manufacturer). The offer may include meta-data specifying the tracking time period, as well as parameters defining types of data to track for changes. Certain vendors may not care, for example, how far off-route a user travels, but may care more about how long a user spends at a location. Others may care about whether they can lure users to off-route locations, but may be agnostic about how long the user spends at their location.

The examples shown are illustrative of the types of changes that can be tracked, but do not limit the types. The vehicle may receive tracking data at step 501 and determine if the behavior was associated with a tracking time period, defined by an offer, at step 503. If the data was not associated with any particular tracking, the vehicle may log the data as normal or standard user behavior and stored with respect to a user or vehicle profile at step 505.

On the other hand, if the data was associated with a tracked offer, then the vehicle may determine any number of deviances from standard behavior (represented by deltas in the figures). In this example, for example, the process may determine a delta in frequency of visit at step 507 by comparing how frequently the vehicle stops at a given location or brand-associated location during the tracking period, compared to the previously observed and recorded normal behavior. This particular data point may require tracking multiple stops at a location during the tracking period, so that a fair comparison of frequency of visit may be observed.

The vehicle may also determine a deviance in the duration of a stop at the location, versus a standard stop at that business, that brand or businesses associated with a particular type of good at step 509. This could include measuring the duration of one or more stops during the tracking time period and comparing them to an average duration of previously observed and recorded standard stops, as well as comparing the measured durations to, for example, a longest recorded standard stop and/or range of times representing recorded standard stops.

The vehicle may further determine how long it has been since the offer was heard, at step 511, which may be useful as an indicator of offer effectiveness, since the longer a user goes since hearing, the offer, the less likely it may be that the behavior was affected by the offer (especially for repetitively purchased goods, such as fuel and food).

The vehicle may additionally determine a spending change, if purchase data is available, at step 513. This may require communication with an in-vehicle purchase system included in the tracking vehicle and/or a mobile device purchase or payment system, and may further require user approval (as may all the data gathering). Any and all changes from previously observed and recorded standard behavior, indicated by data tracked outside the advertisement tracking windows, may be reported by the vehicle at 515.

Offer providers may have an incentive to set appropriate time windows for offer tracking as well, to avoid ascribing standard user behavior to an offer. That is, an excessively long time window may result in tracking behavior that is no longer reflective of having heard the offer. In other examples, manufacturers may impose limits on when the data can be tracked, what data can be tracked, and for how long.

The illustrative embodiments allow for improved observation of user behavior, via vehicle tracking, following presentation of an offer. Since the vehicle is capable of determining both the fact of offer presentation, as well as travel behavior following the offer, it can observe how user behavior changes for a time period following the offer. Moreover, the vehicle can track behavior data for hundreds of offers at once, and aggregation of this data can provide an improved snapshot of how certain offers affect group-behavior over time.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to
insert, during playback of a media content stream, an offer including a tracking characteristic;
store the tracking characteristic in a vehicle memory;
record vehicle travel data corresponding to the tracking characteristic, responsive to storing the tracking characteristic;
based on comparison of the vehicle travel data to previously-recorded vehicle data, identify at least one change in user behavior indicated by the recorded data; and
report the change in vehicle behavior, the recorded data, and an identification of the otter, responsive to identifying the change in vehicle behavior.

2. The system of claim 1, wherein the processor is further configured to transmit the tracking characteristic to a mobile device in communication with the vehicle.

3. The system of claim 2, wherein the processor is further configured to exchange information with the mobile device to obtain tracking information, gathered by the mobile device, corresponding to the tracking characteristic.

4. The system of claim 1, wherein the tracking characteristic includes a duration of time over which tracking should persist.

5. The system of claim 4, wherein the duration of time is measured as a number of trips.

6. The system of claim 1, wherein the tracking characteristic includes tracking stop duration at a stop location associated with the offer.

7. The system of claim 1, wherein the tracking characteristic includes tracking off-route travel time or distance from a predefined route to reach a stop associated with the offer.

8. A method comprising:
identifying a business located at a vehicle stopping location indicated by a vehicle entering a park state;
determining that the business corresponds to an offer previously presented by the vehicle within a tracking time period defined by data included with the offer;
recording data, of a type specified by the data included with the offer, related to the stop; and
reporting the recorded data along with identification of the offer.

9. The method of claim 8, wherein the data related to the stop includes a stop duration.

10. The method of claim 8, wherein the data related to the stop includes an off-route distance traveled from a predefined route to reach the stop.

11. The method of claim 8, wherein the tracking time period is defined based on a number of vehicle trips.

12. The method of claim 8, further comprising comparing the recorded data to previously-observed user data recorded for stops at the business to determine a change in user behavior.

13. The method of claim 12, further comprising reporting the determined change.

14. The method of claim 8, further comprising communicating with a user mobile device to determine if the mobile device recorded data indicating entry into the business.

15. A non-transitory storage medium storing instructions that, when executed by a processor, cause the processor to perform the method comprising:
determining a user stop at a business for which an offer was previously presented in-vehicle, the stop being within a predefined time window following presentation of the offer and defined by the offer;
recording user data relating to the stop, the offer defining which data to record;
determining a change from previously-observed user behavior recorded with respect to a brand associated with the business, by comparing the recorded user data to previously observed and recorded data; and
reporting the deviance, including identification of the offer.

16. The storage medium of claim 15, wherein the change includes an increased frequency with which a vehicle visits the brand over a predefined period of time.

17. The storage medium of claim 15, wherein the change includes an increased duration spent by the vehicle at the stop.

18. The storage medium of claim 15, wherein the change includes an increased amount of money spent by a vehicle occupant at the business.

19. The storage medium of claim 15, wherein the reporting further includes reporting a duration of time since the offer was presented.

20. The storage medium of claim 15, wherein the time window is defined based on a number of vehicle trips.
